(19) United States
(12) Patent Application Publication
(10) Pub. No.: US 2023/0047428 A1
(43) Pub. Date: Feb. 16, 2023

(54) METHOD FOR AUTHENTICATION BETWEEN A CONTROL MODULE AND A LIGHTING MODULE FOR A MOTOR VEHICLE

(71) Applicant: VALEO VISION, Bobigny (FR)

(72) Inventors: Patrice VOIRIN, Bobigny (FR); Houssem KOUKI, Bobigny (FR); Feng YANG, Bobigny (FR); Eric DONNAT, Bobigny (FR); Rodrigo CARBONELL, Bobigny (FR)

(73) Assignee: VALEO VISION, Bobigny (FR)

(21) Appl. No.: 17/763,341

(22) PCT Filed: Sep. 24, 2020
(86) PCT No.: PCT/EP2020/076638

§ 371 Date: Oct. 17, 2022

(30) Foreign Application Priority Data
Sep. 27, 2019 (FR) 1910735

(51) Int. Cl. H04L 9/08; H04L 9/32

(52) U.S. Cl. CPC H04L 9/0822; H04L 9/3236

(57) ABSTRACT

A method for authentication between a control module and a lighting module for a motor vehicle, in which at least one of the two modules is a transmitter module, the other being a receiver module, the two modules comprising a unit for transmitting/receiving data and being linked by a data communication channel that enables the modules to exchange data. The method including transmitting of data describing at least one authentication factor from the transmitter module to the receiver module, verification of the authentication factor by means of a calculation unit, and abandoning communication, in the receiver module, with the transmitter module if the verification fails, or otherwise continuing communication.

### CROSS-REFERENCE TO RELATED APPLICATIONS

This application is filed under 35 U.S.C. § 371 U.S. National Phase of International Application No. PCT/EP2020/076638 filed Sep. 24, 2020 (published as WO2021058610), which claims priority benefit to French application No. 1910735 filed on Sep. 27, 2019, the disclosures of which are herein incorporated by reference in their entirety.

### TECHNICAL FIELD

The invention relates to lighting modules for motor vehicles. In particular, the invention relates to such modules involving matrix light sources.

### BACKGROUND OF THE INVENTION

A light-emitting diode (LED) is a semiconductor electronic component capable of emitting light when it is subjected to an electric current having at least one threshold intensity. In the automotive field, LED technology is increasingly being used for numerous light signaling solutions. LED matrices are of particular interest in the field of automotive lighting. Matrix light sources can be used for “leveling”-type functions, i.e. adjusting the height of the emitted light beam according to the attitude of the vehicle and the profile of the road. Other applications include DBL (“digital bending light”) which corresponds to adjusting the direction of the emitted light beam in order to follow the road in the horizontal plane, ADB (“adaptive driving beam”) which corresponds to an anti-dazzle function that generates shaded areas in the light beam emitted by a high beam so as not to disrupt other road users, as well as functions for projecting patterns on the ground using the pixelated light beam

### BRIEF SUMMARY OF THE INVENTION

It is known practice to use light sources with different types of technology for the aforementioned lighting applications. This may include, for example, monolithic technology, according to which a large plurality of LED-type elementary sources, equivalent to pixels, are etched into a common semiconductor substrate. Integrated electrical connections allow the pixels to be activated independently of one another. Another known technology is that of microLEDs, which produces a matrix of LEDs of small size, typically smaller than 150 μm. There are also modules of micromirror, or DMD (“digital micromirror device”), type, which involve a projection technology using an intensity modulator on a uniform beam. Micromirrors, the position of which is controlled by means of piezoelectric elements, are oriented so as to selectively reflect an incident light beam, so that each micromirror corresponds to an elementary source of the pixel matrix thus produced. The light from a source is directed onto the matrix of micromirrors by an optic. This light therefore has a variable distribution from one module to another because of positioning and manufacturing tolerances in the optics and in the light source. This causes a variable maximum intensity from one module to another, for a given pixel. In this case, each pixel will have a different maximum intensity depending on the command transmitted thereto. Such lighting devices are designed using mass production methods. There has to be a certain amount of play between the constituent elements of the lighting and/or signaling device on the one hand to allow easy assembly, and on the other hand because the parts are generally not machined but instead molded in plastic, which allows the production costs to be kept down.

It is worth emphasizing, in particular, the difficulty in perfectly aligning a micromirror matrix with the projection optics portion, which generally comprises at least one lens. Due to the high numerical aperture of the lens used for the projection function, the projection quality of the image decreases significantly if the lateral offset from the optical axis reaches a few micrometers. In practice, projected image distortions are therefore inevitable using solutions known in the prior art. Each projection module of this type has its own set of optical characteristics, in particular geometric aberration characteristics, including optical distortion and spherical aberration properties. During the production of micromirrors, geometric aberrations may be introduced. All of these elements result in non-uniform behavior of the matrix light source.

All of these aforementioned modules have their own characteristics related to the combination of the manufacturing tolerances of the components. During the production of semiconductor components such as LEDs or LED matrices, direct current variations are currently unavoidable. As a result, in a given LED matrix for the same load current, the LEDs emit light beams with variable, non-uniform intensities. While it is possible to correct projection setpoints in order to take into account the electronic and/or optical specificities of a lighting module, when a fault occurs at the lighting module, it is nonetheless important to be able to project a default image that does not dazzle other road users.

When pairing a control module for a motor vehicle with a lighting module, data describing the characteristics of one or the other of the modules may be exchanged between the modules in order to be able to take account thereof in the operation of the motor vehicle. These parameters are specific to the instance of the lighting module and may be different between two lighting modules originating from the same manufacturing process. It is therefore important to be able to ensure consistency between the parameters exchanged during pairing and the parameters used during operation of the lighting module—all the more so in the event of a potential change in lighting module.

One object of the invention is to overcome at least one of the problems posed by the prior art. More specifically, the object of the invention is to propose a method for authentication between a control module for a motor vehicle and a lighting module controlled thereby.

According to a first aspect according to the invention, a method for authentication between a control module and a lighting module for a motor vehicle is proposed, in which method at least one of the two modules is a transmitter module, the other being a receiver module, the two modules comprising a data transmission/reception unit and being linked by a data communication channel that allows the modules to exchange data. The method is noteworthy in that it comprises the steps of

a) transmitting data describing at least one authentication factor from the transmitter module to the receiver module;

b) following receipt of said data by the receiver module, verifying the authentication factor by means of a computing unit;

c) at the receiver module, breaking off communication with the transmitter module if said verification fails, otherwise continuing communication.

Preferably, the authentication factor may comprise an indication of a date, or of a counter of data exchanges between the two modules.

Preferably, each of the two modules comprises a clock, the clocks of the two modules being synchronized. Preferably, a counter may be initialized at a common value when pairing the lighting module and the control module. Preferably, the counter may be incremented on transmission and/or reception of a message at each of the two modules.

The authentication factor may preferably comprise cryptographically encrypted data, the receiver module comprising a memory element in which are stored verification data allowing said encrypted data to be verified.

Preferably, the cryptographically encrypted data may comprise a hash value of a date indication, or of a counter of data exchanges between the two modules.

The method may preferably comprise a preliminary step of exchanging public encryption keys between the two modules, said encryption keys forming part of public/private encryption pairs associated with the two modules, respectively.

Preferably, the authentication factor may comprise data signed or encrypted using the private key of the transmitter module.

The transmitter module may preferably be the control module and said data describing the at least one authentication factor may be included in a header of a data packet, the data in the packet describing at least part of a lighting setpoint, a default setpoint, or data relating to the motor vehicle.

Preferably, the transmitter module may be the lighting module and said data describing the at least one authentication factor may be included in a header of a data packet, the data in the packet describing at least some calibration data relating to a light source of the lighting module.

The communication between the two modules may preferably be broken off following a predetermined number of failures to verify the data describing an authentication factor of the transmitter module.

According to another aspect of the invention, a lighting system for a motor vehicle is proposed. The system is noteworthy in that it comprises a control module and a lighting module, the two modules comprising a transmission/reception unit and being linked by a data communication channel that allows the modules to exchange data. The system is further noteworthy in that the control module and the lighting module are configured to implement the steps of the method according to one aspect of the invention.

Preferably, the lighting module may comprise a matrix light source.

The matrix light source may preferably comprise a monolithic source, comprising elementary light-emitting light sources with semiconductor elements that are etched into a common substrate and are activatable independently of one another.

The matrix light source may preferably comprise a microLED-type matrix, comprising a matrix of elementary sources produced by light-emitting diodes, LEDs, of small size, typically smaller than 150 μm.

The matrix light source may preferably comprise a micromirror device, or DMD (digital micromirror device), in which an elementary source comprises a micromirror in a matrix, which selectively reflects an incident light beam according to its position.

The lighting module may preferably comprise a control unit. The control unit may preferably be configured to control said matrix light source.

The lighting module may preferably comprise a memory element in which data allowing the module to be authenticated are stored. Preferably, the lighting module may comprise a processor programmed to encrypt and/or sign data by means of a cryptographic key stored in said memory element.

Preferably, a failure at the lighting module and/or at the control module for the motor vehicle may be detected when the decryption of the data is unsuccessful or when said signature cannot be validated.

The lighting module may preferably comprise a data reception/transmission unit. The data reception and transmission unit may preferably comprise a network interface capable of receiving/sending data over a data bus internal to the motor vehicle. For example, the bus may be an Ethernet bus, a bus of Gigabit Multimedia Serial Link, GMSL, type, or a bus using low-voltage differential signaling, LVDS, technology, such as an FPD-Link III bus.

The computing unit may preferably comprise a microcontroller element. The control unit may preferably comprise a chip of field-programmable gate array, FPGA, application-specific integrated circuit, ASIC, or complex programmable logic device, CPLD, type. These elements are configured using an appropriate computer program to implement the described functionalities.

According to yet another aspect of the invention, a computer program comprising a sequence of instructions is proposed which, when the instructions are executed by a processor, result in the processor implementing a method according to one aspect of the invention.

According to another aspect of the invention, a non-transitory computer-readable storage medium is proposed, said medium storing a computer program according to the preceding aspect of the invention.

By using the measures proposed by the present invention, it becomes possible to provide a method for authentication between a control module for a motor vehicle and a lighting module controlled thereby. This allows the two modules to automatically ensure that the module that transmits data thereto (for example lighting setpoints to be implemented) is indeed the module with which a pairing process was previously undertaken during assembly of the motor vehicle. When, during pairing, parameters describing, for example, the attitude of the vehicle, the position of the lighting module within the motor vehicle, or calibration data for a light source of the lighting module are exchanged, it is important that the modules are able to ensure that the initially exchanged parameters are still valid. This is possible using the authentication method according to aspects of the invention. Successful authentication may, for example, mean that the modules have been paired correctly beforehand, whereas unsuccessful authentication means that one or the other of the modules has been changed in the meantime, that new pairing is necessary, or that one or the other of the modules is in failure mode.

### BRIEF DESCRIPTION OF THE DRAWINGS

Other features and advantages of the present invention will be better understood with the aid of the description of the examples and of the drawings, in which:

FIG. 1 shows a method for authentication between a control module and a lighting module according to one preferred embodiment of the invention; and

FIG. 2 is an illustration of a lighting system in accordance with one preferred embodiment of the invention.

### DETAILED DESCRIPTION OF THE INVENTION

Unless specified otherwise, technical features that are described in detail for one given embodiment may be combined with the technical features that are described in the context of other embodiments described by way of example and without limitation.

The description focuses on the elements of a lighting module for a motor vehicle that are required to understand the invention. Other elements, which in a known manner form part of such modules, will not be mentioned or described in detail. For example, the presence and operation of a converter circuit involved in supplying electrical power to a matrix light source, known per se, will not be described in detail. The same applies for optical elements such as lenses, for example.

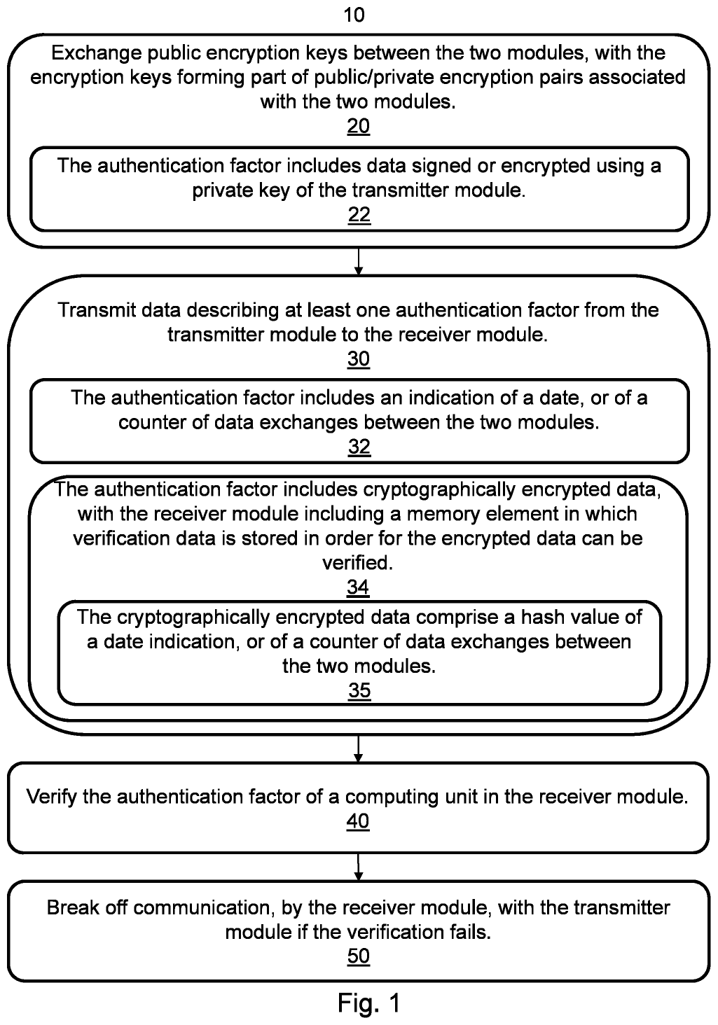

FIG. 1 shows a method 10 for authentication between a control module and a lighting module according to one embodiment of the invention. In block 20, public encryption keys are exchanged between the two modules, with the encryption keys forming part of public/private encryption pairs associated with the two modules. In block 22, An authentication factor includes data signed or encrypted using a private key of the transmitter module. In block 30, data describing at least one authentication factor is transmitted from the transmitter module to the receiver module. In block 32, the authentication factor includes an indication of a date, or of a counter of data exchanges between the two modules. In block 34, the authentication factor includes cryptographically encrypted data, with the receiver module including a memory element in which verification data is stored in order for the encrypted data can be verified. In block 35, the cryptographically encrypted data comprise a hash value of a date indication, or of a counter of data exchanges between the two modules. In block 40, the authentication factor is verified by a computing unit in the receiver module. In block 50, communication is broke off, by the receiver module, with the transmitter module if the verification fails.

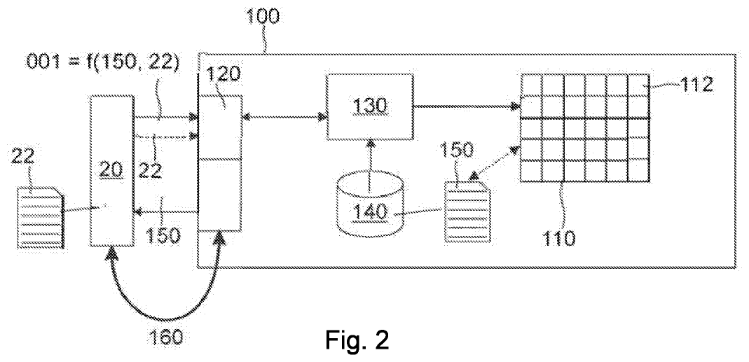

FIG. 2 illustrates a lighting system in accordance with one preferred embodiment of the invention. The lighting system includes a control module 20, as well as a lighting module 100 for a motor vehicle. Depending on whether data are transmitted from the control module 20 to the lighting module or vice versa, on each transmission at least one of the two modules is a transmitter module, the other being a receiver module. The two modules 20, 100 each comprise a data transmission/reception unit and they are linked by a data communication channel that allows them to exchange data. Data that describe at least one authentication factor 160 for the transmitter module are transmitted to the receiver module. The can be received at the receiver module and verified by means of a computing unit, such as a data processor programmed for this purpose by a suitable computer program. If verification fails, communication between the modules is broken off. Preferably, the module in question is put into failure mode and a corresponding message is sent to a central unit of the motor vehicle. If verification is successful, communication continues. While the authentication procedure may be performed on every data packet, it may alternatively be performed periodically.

The authentication function may, for example, comprise the exchange of public cryptographic keys between the two modules in question, thus allowing the reciprocal verification of the authenticity of data signed by means of the corresponding private cryptographic keys. Alternatively or in addition, the control/computing unit 130 for the lighting module 100 sends an acknowledgment of receipt to the control module 20 for a received data packet, the acknowledgment of receipt comprising at least one authentication factor 160 that allows the microcontroller that forms the computing unit 130 to be authenticated. The data packet may, for example, contain calibration data, and/or default image data and/or data for generating a default image and/or all or part of an image and/or of a group of images, and/or a packet from a compressed video stream. In one preferred embodiment, this authentication is not performed on all of the packets. In this way, the corresponding computing load is lightened and smoothed out over time. Still alternatively, the authentication function may comprise sending, from the control module 20 for the motor vehicle to the control unit 130 for the lighting module, of a header for a sent data packet, the header comprising a part allowing the control module 20 to be authenticated, the data packet being of the same type as defined above. Advantageously, this authentication is not performed on all of the packets. In this way, the corresponding computing load is lightened and smoothed out over time.

In order to perform the authentication function, the lighting module 100 and the control module 20 for the motor vehicle comprise computing means for generating the header or the acknowledgment of receipt used for authentication, respectively. Preferably, the authentication factor is generated according to a time or a date, which may be expressed in any unit of time, for example in milliseconds, or a counter counting exchanges or computing cycles, or another element that changes with the number of exchanges, which may be reset when it exceeds a predefined size.

If the two modules comprise synchronized clocks and/or counters, both may verify the data in the header by comparing them with the value from its own clock, or from its corresponding own counter. The data in the header may also be hashed using a cryptographic hash function. The receiver module may generate a hash value from its corresponding counter. Only if the two counters of the communicating modules are strictly identical will the hash value thus obtained be identical to that of the header.

In the event that authentication between the controller and the microcontroller fails, the lighting function may be put into a communication failure mode. Advantageously, the failure mode is activated only in the event of repeated authentication failures, which makes it possible to avoid activating failure mode if the link has been disrupted, for example by transient electromagnetic interference, which is particularly advantageous in the case of an authentication function using headers or acknowledgments of receipt.

In the case where the control unit 130 comprises a computer, it may implement a data exchange encryption function, in which data encrypted by the control module 20 for the motor vehicle are decrypted by the computer. Advantageously, the computer has a method for determining if the stream has not been decoded correctly. If the stream has not been decoded correctly, the computer may go into a communication failure mode. The communication failure mode may involve the following procedures, taken alone or in combination:
stopping the lighting function or the lighting module projecting a default image,
the control module 20 generating a failure signal sent to a central management system of the vehicle,
the computer entering an authentication mode in which the computer continues launching an authentication procedure with respect to the computer for the control module 20 (or vice versa). In the authentication mode, the sending of data packets may be interrupted.

Once the initial authentication has ended successfully, the rest of the communication between the modules 20, 100 may, according to one preferred embodiment which will be described in a non-limiting manner below with reference to the illustration of FIG. 2, relate to a method for generating a default image. It should be noted that the authentication process may be carried out each time a data packet is transmitted, or else periodically.

The lighting module 100 preferably comprises a matrix light source 110 grouping together a plurality of elementary light sources 112. In the example illustrated, this is a matrix of LEDs without, however, the invention being limited to this example. The matrix light source may also be produced by a micromirror device, for which each mirror is designed to generate one elementary light beam of a matrix. The module comprises a data reception and transmission unit 120; this is, for example, an interface capable of receiving and decoding messages over a data bus internal to the motor vehicle, such as a CAN (Controller Area Network) bus.

The data reception unit 120 is capable of receiving/sending data from/to at least one control module for the motor vehicle—in particular, it may carry out the exchanges of steps a) or b) of the authentication method described above. The control module 20 comprises data 22 relating to the motor vehicle, such as its attitude, the position of the lighting module in the motor vehicle, or other data. The module 100 further comprises a memory element 140, such as a flash-type memory, to which the control unit 130 is functionally connected and has read access, and in which calibration data 150 specific to the matrix source 112 are stored. By way of example, the data may comprise, for each elementary light source 112, a value indicating the difference in brightness with respect to the average brightness of the matrix source 110, possibly over a range of load current strengths. The data 150 may nevertheless comprise more complex optical or geometric calibration parameters, without thereby departing from the scope of the present invention.

The exchange of data between the light module 100 and the control module 20 for the motor vehicle after pairing the two modules allows some advantageous applications. In particular, it is proposed to combine data relating to the vehicle 22, such as, for example, orientation, position, or attitude parameters of the vehicle, or information relating to luminous fluxes emitted by other headlights of the vehicle, which are a priori only available at the control module 20, with the calibration data 150, available at the lighting module 100 and specific to the matrix source 110 installed therein. This information is used, according to one preferred embodiment but in a non-limiting manner, by the control module 20 for the motor vehicle to generate a default image or setpoint 001. To do this, the relevant portion of the calibration data 150 is first transmitted from the lighting module 100 to the control module 20, as indicated by the solid arrow in FIG. 2. Specifically, the control module for the motor vehicle generally has greater computing capacity than the control unit 130 for the lighting module.

Alternatively, this computation may be performed by the control unit 130 for the lighting module after a corresponding exchange of the data 22 required for this computation between the control unit for the motor vehicle on the one hand and the control unit for the lighting module on the other hand, represented by the dashed arrow in FIG. 2.

A default image is an image that is projected by the module when a fault or failure is detected. Thus, the module may preferably comprise an electronic error detection circuit (not illustrated), or a microprocessor programmed for this purpose by a suitable computer program. The error detection circuit is configured to detect, for example, that the data received by the control module for the motor vehicle are inconsistent, or that the connection between the control module for the motor vehicle and the lighting module 100 is no longer reliable. Following this detection of an error, the default image 001 is projected instead of the current setpoint image, with the aim of avoiding potential dazzling of other road users. The default image is generated to take into account the specificities of the matrix light source 110 on the one hand, and of the vehicle equipped therewith on the other hand. Thus, the default image may, for example, be generated precisely and automatically for each motor vehicle and each lighting module with which the vehicle is equipped. Preferably, the default image resulting from this method is transmitted to the lighting module, which stores it permanently in a dedicated memory element. In the event of communication failure between the control module 20 for the motor vehicle and the lighting module 100, the default setpoint then serves as a control for the matrix light source. The default setpoint or image may, for example, correspond to low-beam headlight illumination. In particular, this image may correspond to a low-beam headlight cut-off. Specifically, the cut-off must be well defined in order to satisfy the regulations in force. The precise generation of the default setpoint, taking into account all of the described parameters, makes it possible in particular to prevent other road users from being dazzled when the default setpoint is projected by the lighting module.

According to one preferred embodiment, in the absence of a fault and following pairing of the motor vehicle with the lighting module, the control module 20 may, for example, send a lighting setpoint to the lighting module 100, which is responsible for controlling the matrix light source according to the received setpoint. Such a setpoint may, for example, comprise a brightness value, such as a grayscale level, encoded on a predetermined number of bits, to be produced by each of the elementary light sources 112. The lighting setpoint may therefore be a digital image, and it may in particular be a frame from a stream of such images, constituting a video signal. The control unit 130 is intended to control said matrix light source according to said lighting setpoint. The control unit may be connected to, or comprise, a circuit for driving the electrical power supply for the elementary light sources 112, which is controlled in order to supply the elementary light sources with power in such a way as to implement the lighting setpoint.

In order to ensure uniform light intensity, the control unit 130 adjusts the setpoint values received by the control module 20 by adding thereto or subtracting therefrom the respective differences described in the calibration data 150, before controlling the elementary light sources in accordance with the result. The data 150 may nevertheless comprise more complex optical or geometric calibration parameters, without thereby departing from the scope of the present invention. In such a case, instead of acting only at the level of each light source or at the level of each pixel individually, the correction of the original setpoint may advantageously produce a correction at the level of the entire setpoint, i.e. at the level of the entire image to be projected, or at the level of at least a portion or a region of this image. For example, the image projected without the setpoint correction might exhibit a concave curved appearance due to the projection optics in the vicinity of the projection region. Producing the precorrected setpoint, which takes into account the calibration data including the geometric deformation imposed by the projection optics, results in a projected image exhibiting a geometry closer to the desired, non-curved geometry. To apply a correction for geometric aberrations, a deformation is applied to the entire original setpoint image. As this is discretized, this deformation causes degradation of the information contained in the initial image. It is therefore advantageous for the setpoint image transmitted from the control unit for the vehicle to the control unit to have a resolution higher than the projection resolution of the light module.

The control unit 130 comprises a microcontroller element that has sufficient computing power to correct the setpoint 10, or a stream of setpoints, in real time, by applying the calibration data 150 thereto.

According to one preferred embodiment, the lighting module is arranged so as to transmit at least some of the calibration data 150, and preferably all of this data, to the control module 20. This is, for example, performed in a phase of initializing the lighting module. In order to guarantee uniform light intensity, the control module 20 takes into account the calibration data 150 thus received in order to determine the setpoint image. For example, the control module 20 adjusts the setpoint values by adding thereto or subtracting therefrom the respective differences before transmitting the result to the lighting module 100. The data 150 may nevertheless comprise more complex optical or geometric calibration parameters, without thereby departing from the scope of the present invention. In this embodiment, the control unit 130 is freed from the task of correcting the setpoint, and it may be performed by a less expensive microcontroller element that has less computing power.

It goes without saying that the described embodiments do not limit the scope of the protection of the invention. By referring to the description that has just been given, other embodiments may be contemplated without otherwise departing from the scope of the present invention.

The scope of protection is defined by the claims.

What is claimed is:

1. A method for authentication between a control module and a lighting module for a motor vehicle, in which at least one of the two modules is a transmitter module, the other being a receiver module, the two modules each including a data transmission/reception unit and being linked by a data communication channel that allows the modules to exchange data, the method comprising:
transmitting data describing at least one authentication factor from the transmitter module to the receiver module;
verifying the authentication factor by a computing unit in the receiver module; and
breaking off communication, by the receiver module, with the transmitter module if the verification fails.

2. The method as claimed in claim 1, wherein the authentication factor includes an indication of a date, or of a counter of data exchanges between the two modules.

3. The method as claimed in claim 1, wherein the authentication factor includes cryptographically encrypted data, with the receiver module including a memory element in which verification data is stored in order for the encrypted data can be verified.

4. The method as claimed in claim 3, wherein the cryptographically encrypted data comprise a hash value of a date indication, or of a counter of data exchanges between the two modules.

5. The method as claimed in claim 1, further comprising exchanging public encryption keys between the two modules, with the encryption keys forming part of public/private encryption pairs associated with the two modules.

6. The method as claimed in claim 1, wherein the authentication factor includes data signed or encrypted using a private key of the transmitter module.

7. The method as claimed in claim 1, wherein the transmitter module is the control module and in that the data describing the at least one authentication is included in a header of a data packet, with the data in the data packet describing at least part of a lighting setpoint, a default setpoint, or data relating to the motor vehicle.

8. The method as claimed in claim 1, wherein the transmitter module is the lighting module and in that the data describing the at least one authentication is included in a header of a data packet, with the data in the data packet describing at least some calibration data relating to a light source in the lighting module.

9. The method as claimed in claim 8, wherein the light source includes a matrix light source.

10. The method as claimed in claim 1, wherein the communication between the two modules is broken off following a predetermined number of failures to verify the data describing an authentication factor of the transmitter module.

11. A lighting system for a motor vehicle, the system comprising:
a control module and a lighting module, each of the two modules including a transmission/reception unit and the two modules being linked by a data communication channel that allows the two modules to exchange data, wherein the control module and the lighting module are configured to transmit data describing at least one authentication factor between the two modules, verify the authentication factor by means of a computing unit in on of the two modules, and break off communication between the two modules if the verification fails.

12. (canceled)
